(19) United States
(12) Patent Application Publication
(10) Pub. No.: US 2012/0035852 A1
(43) Pub. Date: Feb. 9, 2012

(54) PROCESSING SEISMIC DATA

(75) Inventor: Pascal Edme, Cambridge (GB)

(73) Assignee: Schlumberger Technology Corporation

(21) Appl. No.: 13/144,597

(22) PCT Filed: Jan. 19, 2010
(86) PCT No.: PCT/IB10/00088

§ 371 Date: Oct. 13, 2011

Related U.S. Application Data
(60) Provisional application No. 61/145,639, filed on Jan. 19, 2009.

(51) Int. Cl. G06F 19/00

(52) U.S. Cl. 702/14

(57) ABSTRACT

A method of processing multi-component seismic data is provided that comprises determining, in the time-offset domain, a first partition rate for a first event from the multi-component seismic data. Information about near-receiver properties of the earth may be obtained from the first partition rate. The method may further comprise determining, in the time-offset domain, at least a second partition rate for the first event from the multi-component seismic data and/or at least a third partition rate for a second event. Further information about near-receiver properties of the earth can be obtained from the second and/or third partition rate.

### FIELD

The present invention relates to a method of processing seismic data, in particular multicomponent seismic data.

### BACKGROUND

FIG. 1 is a schematic illustration of the principles of a seismic survey. This seismic survey is intended to provide information about a target geological reflector 3 disposed within the earth's interior.

The seismic survey shown in FIG. 1 includes a seismic source 4 disposed on the earth's surface 1. A seismic sensor 5, referred to hereinafter as a “receiver”, is also disposed on the earth's surface, at a distance from the seismic source 4. In use, the seismic source 4 is caused to emit a pulse of seismic energy into the earth, and seismic energy reflected from the target geological reflector 3 is detected by the receiver 5.

FIG. 1 illustrates a land-based seismic survey. However, seismic surveying of this general type is not restricted to land, and may be carried out in a marine environment or in the land-sea transition zone. For example, marine seismic surveying arrangements are known in which one or more seismic sources are towed by a survey vessel; in such an arrangement, the receivers may be disposed on the sea-bed (a so-called “ocean bottom cable” survey or OBC survey), or the receivers may also be towed by a survey vessel. Furthermore, a land-based seismic survey is not limited to the configuration shown in FIG. 1(a), and it is possible for the seismic source or the seismic receiver to be disposed within the earth's surface. For example, in a reverse vertical seismic profile (VSP) seismic survey a seismic source is disposed within a bore hole rather than on the earth's surface.

Only one seismic source 4 and one seismic receiver 5 are shown in FIG. 1 for ease of explanation but, in general, a practical seismic survey will contain one or more arrays of sources and one or more arrays of receivers.

The seismic sources used in a land-based survey are normally vibrated or explosive sources. If vibrators are used it is possible to perform a “multi-component” survey, using a multi-component vibrator that produces (usually) three orthogonal source motions (two source motions in orthogonal horizontal directions and one source motion in the vertical direction). If a seismic receiver is used that can record particle motion in three orthogonal directions, then it is possible to perform a 3C×3C (or 9C) seismic survey.

A suitable receiver for this is one that can measure three orthogonal components of the particle motion (where “particle motion” includes displacement, velocity, acceleration and higher time-derivatives of displacement) at the receiver, for example a receiver that contains three orthogonal geophones—two geophones for measuring two orthogonal horizontal components of the particle motion at the receiver, and a third geophone for measuring the vertical component of the particle motion at the receiver. These components are generally referred to as X, Y and Z components, where the Z-component is the vertical component and the X and Y components are two orthogonal horizontal components. Usually, the X-direction is defined to be parallel to a line passing through the source and receiver (the “in-line” direction), and the Y-direction is defined to be perpendicular to a line passing through the source and receiver (the “cross-line” direction).

Multi-component vibrators, which operate by imposing tractions on the earth's surface, emit two distinct wave types, known as P-waves (pressure waves) and S-waves (shear waves). (In fact there are two types of S-waves known as Sv waves and Sh waves, but the distinction between these two types of shear waves is not relevant for the present invention and the following description will refer simply to “shear waves” for simplicity.) The relative amplitudes of these different wave-types in seismic energy emitted by a multi-component vibrator vary depending on the direction of propagation of the seismic energy. A multi-component receiver records both P-waves and S-waves—for example, when a geophone measures a component of the wavefield at the earth's surface, both P-waves and the two-types of S-waves are recorded without distinction. In general, a geophone oriented along the z-axis (vertical axis) records primarily P-waves and a geophone oriented along the x-axis (source-receiver axis) records primarily S-waves—although in practice a geophone oriented along the z-axis may also record a small component of S-waves and a geophone oriented along the x-axis may also record a small component of P-waves.

It is possible for “mode conversion” to occur, in which seismic energy propagating as a P-wave [or S-wave] undergoes partial conversion to an S-wave [or P-wave]. Mode conversion may occur upon refraction, for example upon refraction when seismic energy from the source 4 passes through the overlying reflector 2 of FIG. 1. The mode conversion amplitude depends on the contrast in physical properties between the layers of the earth on either side of the overlying reflector 2. Mode conversion may also occur on reflection. At a given location a P-wave has a different velocity to an S-wave so that, when mode conversion occurs, the P-wave component and the S-wave component propagate along different paths.

It should be noted that mode conversion will occur independently of the source of the seismic energy. Thus if, for example, an explosive source is used instead of a vibrator source, mode conversion may occur as the seismic energy propagates through the earth.

Where a receiver records P- and S-waves without distinction, a seismic trace acquired at the receiver will include events due to received P-waves (“P-events”) and events due to received S-waves (“S-events”). In many cases it is desirable to separate the P-events in a seismic trace from the S events, since this provides additional information about the earth's interior. In many cases, a geological structure will have a different effect on P-waves than on S-waves. The process of separating the P-events in a seismic trace from the S-events is generally referred to as decomposing the seismic trace into its P- and S-components.

As explained above, in contrast to conventional vertical-component-seismic-data measurements, multi-component sensors enable the recording of seismic data in a vector oriented manner as they can record three orthogonal components of particle motion. By accounting for the measurement of the inline horizontal geophone (X) of the ground in addition to the vertical geophone (Z), more reliable information on the sub-subsurface properties can be obtained. There are three main reasons for this:
S-waves are recorded (mainly on the horizontal components) in addition to the P-waves (mainly on the vertical component). Joint analysis of P- and S-wave data provides important information on lithology (Caldwell, 1999), porosity (Garotta et al., 2002), fracturing (Ata and Michelena, 1995) and anisotropy (Lynn et al., 1996; Tsvankin and Grechka, 2002; Thomsen, 1999).
Multi-component data give access to ellipticity of the particle motion, which can be used to discriminate elliptically polarized events (typically ground-roll noise) from the linearly polarized reflection signal of interest (Shieh and Herrmann, 1990; Kragh and Peardon, 1995; DeMeersman and Kendall, 2005).
Multi-component data give access to polarization angles, which can be used to discriminate mainly vertically polarized P-waves from mainly horizontally polarized S-waves (Montalbetti, and Kanasewich, 1970; Dankbaar, 1985; Esmersoy, 1990).

One attribute that can be obtained from multi-component seismic data is information about the polarisation of the received waves, and more specifically, but not by way of limitation, the Z vs. X polarization angle of P waves. This attribute has been used for a number of applications:
In Earthquake (land) seismology in order to remove the P-waves recorded on the horizontal (radial) component (Reading et al., 2003) by rotation of the components according to the measured P-wave polarization angle.
In sea-bed reflection data (Ocean Bottom Cable) in order to separate the upgoing P- and S-wavefields just below the solid-liquid interface (Wang et al., 2002), again by rotation of the components but in the tau-p domain where tau is intercept time and p is horizontal slowness.
In reflection land data in order to remove the P-waves recorded on the horizontal component by adaptive subtraction in the tau-p domain (Edme and Singh, 2008).

The geological structure of the earth is not uniform. One problem in processing marine seismic data is that frequently there is a layer 1a at or near the surface 1 whose properties may well be significantly different from the properties of the underlying geological structure (hereinafter referred to as the “basement”). This can occur if, for example, there is a layer at or near the earth's surface that is less consolidated than the basement. In this case, the velocity of seismic energy may be significantly lower in the surface or near-surface layer 1a than in the basement, and such a surface or near-surface layer is thus generally known as a “low-velocity layer” (or LVL). Alternatively the velocity of seismic energy may be significantly higher in the surface or near-surface layer 1a than in the basement, for example in a permafrost area having a shallow, frozen layer at the surface. If the surface or near-surface layer 1a is laterally heterogeneous, so that the velocity of seismic energy in the layer 1a varies with lateral position across the surface or near-surface layer 1a, these lateral variation in velocity will produce a laterally-varying shift in the travel time of seismic energy (and so the shift may be different between one receiver location and another). These shifts in travel time are generally known as “static shifts”, or just “statics”.

The low-velocity layer 1a is shown as a surface layer FIG. 1, but it need not extend to the surface and there could be a further layer overlying the low-velocity layer.

The static shift generated by a heterogeneous surface or near-surface low-velocity layer 1a depends on the thickness of the layer, and on the velocity of propagation of seismic energy through the layer. Lateral variations usually occur in both the thickness of a low-velocity layer 1a and the propagation velocity through the layer, so that the static shift observed at a seismic receiver at one location is likely to be different from the static shift observed at a receiver at another location. To a first approximation, the entire data set recorded at one receiver will be advanced or delayed by a static time shift relative to data recorded at another receiver.

### SUMMARY

A first aspect of the present invention provides a method of processing multi-component seismic data, the method comprising: determining, in the time-offset domain, a first partition rate for a first event from the multi-component seismic data; and obtaining first information about near-receiver properties of the earth from the first partition rate. By “near-receiver properties” is meant properties of the earth at or near the location of the receiver at which the seismic data were acquired, in particular properties at, or at shallow depths below, the receiver location—for example at locations within the near surface layer 1a of FIG. 1. The invention thus allows information to be obtained about the earth's properties just below the earth's surface (in a land-based survey) or about earth's properties just below the seabed (in a survey having receivers disposed on/in the seabed).

In prior art processing of multi-component seismic data, tau-p decomposition methods are used. These implicitly assume a 1D-velocity model, and, therefore, assume a constant S-wave velocity near the surface. Further, for a given horizontal slowness p, the P-wave partition rate (eg polarization angle) is assumed to be the same at all receiver locations. The present invention, however, obtains information about the near-surface properties (for example about the S-wave [P-wave] velocity) from a partition rate determined for a P-wave [S-wave]—for example the polarization angle. This allows more accurate information about the near-surface properties (for example more accurate information about the S-wave [P-wave] velocity) to be obtained. Additionally/alternatively, the invention allows a horizontal profile of the near-surface properties (for example a horizontal profile of the near-surface S-wave [P-wave] velocity) to be obtained, by performing the method for different receiver locations, as the prior art assumption that the partition rate is the same at all receiver locations is not made in the invention.

The method may further comprise: determining, in the time-offset domain, at least a second partition rate for the first event from the multi-component seismic data; and obtaining second information about near-receiver properties of the earth from the second partition rate. Additionally or alternatively the method may further comprise determining, in the time-offset domain, at least a third partition rate for a second event from the multi-component seismic data; and obtaining third information about near-receiver properties of the earth from the third partition rate. This allows further information about the near-receiver properties of the earth to be obtained

The method may further comprise combining the second and/or third information about near-receiver properties of the earth with the first information about near-receiver properties of the earth.

The method may comprise determining the polarisation angle for a P-wave event from the multi-component seismic data and obtaining information about the near-receiver properties of the earth from the determined polarisation angle of the P-wave event and the horizontal slowness of the P-wave event.

The information about the near-receiver properties of the earth may comprise information about the near-surface S-wave velocity

The method may comprise determining the velocity of the S-wave according to:

$$β = \sqrt{\frac{1 - {( 1 + {tan}^{2} φ )}^{- \frac{1}{2}}}{2 {p}^{2}}}$$

where β is the velocity of the S-wave, p is the horizontal slowness of the P-wave event and φ is the polarisation angle of the P-wave event.

The information about near-receiver properties of the earth may alternatively comprise information about the near-surface S-wave velocity and the density of the earth just below the seafloor. This is applicable when the seismic data were acquired at receivers disposed on the seabed, since the polarisation for a P-event in seismic data acquired at receivers disposed on the seabed is dependent also on the density of the earth just below the seafloor.

The method may comprise determining the polarisation angle for at least a second P-wave event from the multi-component seismic data and obtaining information about the near-receiver properties of the earth from the determined polarisation angle of the second P-wave event and the horizontal slowness of the second P-wave event.

The method may be performed for two or more events. Where the method is performed on two or more events acquired at the same receiver, the same results for the near-receiver properties should be obtained for all events, since all events should give the near-receiver properties at one receiver location. Thus, performing the method for two or more events provides redundancy, or allows the results to be averaged to provide a more accurate results.

The method may comprise determining information about the near-receiver properties of the earth for a first frequency. It may further comprise determining, from the P-wave event(s), information about the near-receiver properties of the earth for at least a second frequency.

The method may be performed for two or more different frequencies. Lower frequencies “see” deeper into the earth, whereas high frequencies will only “see” a very short way into the earth, so that, for a particular location, performing the method at a low frequency and performing the method at a high frequency are effectively measuring the near-receiver properties at different depths within the earth. Thus performing the method at different frequencies provides information on how the near-receiver properties vary with depth.

The method may further comprise determining the horizontal slowness of the P-wave event(s) from the multi-component seismic data.

The method may further comprise determining the polarisation angle for an S-wave event from the multi-component seismic data and obtaining information about the near-receiver properties of the earth from the determined polarisation angle of the S-wave event and the horizontal slowness of the S-wave event. Again, it has been realised that the polarisation angle of an S-wave event is not constant for all receiver locations but may be used to obtain information about near-receiver properties (in addition to, or as an alternative to, obtaining information about near-receiver properties from the polarisation angle of a P-event).

The information about the near-receiver properties of the earth may comprise information about the near-surface P-wave velocity and near-surface S-wave velocity. In the case of seismic data acquired at land-based receivers, the polarisation angle of an S-wave event is dependent upon both the near-surface S-wave velocity and the near-surface P-wave velocity.

The information about the near-receiver properties of the earth may comprise information about the near-surface P-wave velocity, near-surface S-wave velocity and the density of the earth immediately below the seafloor. In the case of seismic data acquired at receivers disposed on/in the seafloor, the polarisation angle of an S-wave event is dependent upon both the near-surface S-wave velocity and the near-surface P-wave velocity, and also upon the density of the earth just below the seafloor.

The method may comprise determining the polarisation angle for at least a second S-wave event from the multi-component seismic data and obtaining information about the near-receiver properties of the earth from the determined polarisation angle of the second S-wave event and the horizontal slowness of the second S-wave event.

The method may comprise determining, from the polarisation angle of the S-event(s) information about near-receiver properties of the earth for a first frequency. It may further comprise determining, from the polarisation angle of the S-wave event(s), information about near-receiver properties of the earth for at least a second frequency.

As noted, the method may comprise combining information about near-receiver properties obtained from two or more event and/or two or more partition rates for the same event. This can provide more information about the near-receiver properties, and may allow a parameter of the earth's properties to be extracted. For example, the polarisation angle of an S-wave event is dependent on the near-surface P-wave velocity, near-surface S-wave velocity (and, in the case of seafloor data, on the density of the earth immediately below the seafloor). It is therefore not possible to obtain information about the near-surface P-wave velocity itself from the polarisation angle of an S-wave event, but only information about, in combination, the near-surface P-wave velocity and the near-surface S-wave velocity (and, in the case of seafloor data, the density of the earth immediately below the seafloor).

If the near-surface S-wave velocity at the receiver location is known, from the polarisation angle of a P-event (or otherwise), this may be combined with the information obtained from the polarisation angle of the S-event. For example, in the case of land-data, the near-surface S-wave velocity at the receiver location obtained from the polarisation angle of a P-event may be used to process the information about, in combination, the near-surface P-wave velocity and the near-surface S-wave velocity obtained from the polarisation angle of an S-event (at the same receiver location), to allow the near-surface P-wave velocity to be extracted—so, in more general terms, if near-receiver properties of the earth are obtained from one or more S-wave event(s) and from one or more P-events (at the same receiver location), the near-receiver properties obtained from the P-event(s) may be combined with, or used to process, the near-receiver properties obtained from the P-event(s).

The method may comprise carrying one or more further processing steps on the acquired seismic data taking account of the obtained information about the near-receiver properties of the earth. For example, the near-receiver properties may be used to process acquired seismic data to eliminate, or reduce, the effects of a “static shift” owing to an heterogeneous near-surface or surface layer.

The method may further comprise acquiring the multicomponent seismic data. Alternatively, it may further comprise retrieving the multicomponent seismic data.

Other aspects of the invention provide a corresponding computer-readable medium and apparatus

### BRIEF DESCRIPTION OF THE DRAWINGS

Embodiments of the invention will now be described with reference to the accompanying drawings, in which:

FIG. 1 is a schematic view of a seismic survey;

FIG. 2 illustrates reflection and mode-conversion at a solid/air interface of a P-wave incident at a receiver location;

FIG. 3 illustrates the P-wave partition rate;

FIGS. 4(a) and 4(b) are block flow diagrams of methods according to an embodiment of the invention;

FIGS. 5(a) to (d) illustrate results obtained by an embodiment of the invention;

FIG. 6 illustrates results obtained by an embodiment of the invention;

FIGS. 7(a) to 7(d) are block flow diagrams of methods according to further embodiments of the invention;

FIG. 8 is a block schematic diagram of an apparatus according to an embodiment of the invention;

FIGS. 9(a) to 9(c) are block flow diagrams of methods according to further embodiments of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage device's, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The invention may be implemented with multi-component sensors, eg 3-component sensors, disposed on or in the earth's surface (where disposed “in the earth's surface” is intended to cover a sensor disposed in a shallow hole in the earth's surface). The invention may be implemented with sensors disposed on dry land, or it may be implemented with sensors disposed on/in a part of the earth's surface covered with water (such as for example the well-known “ocean Bottom Cable” (OBC) sensors). Sensors disposed on/in a part of the earth's surface covered with water will be referred to hereinbelow as “seabed” or “seafloor” sensors for convenience, but use of these terms does not exclude the use of sensors disposed on/in a part of the earth's surface covered with fresh or brackish water.

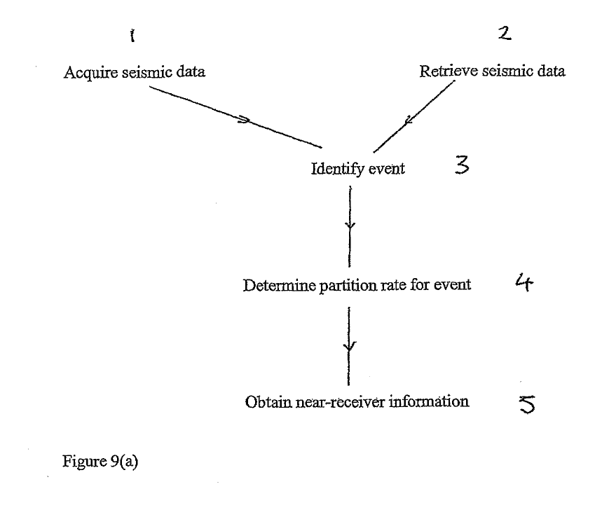

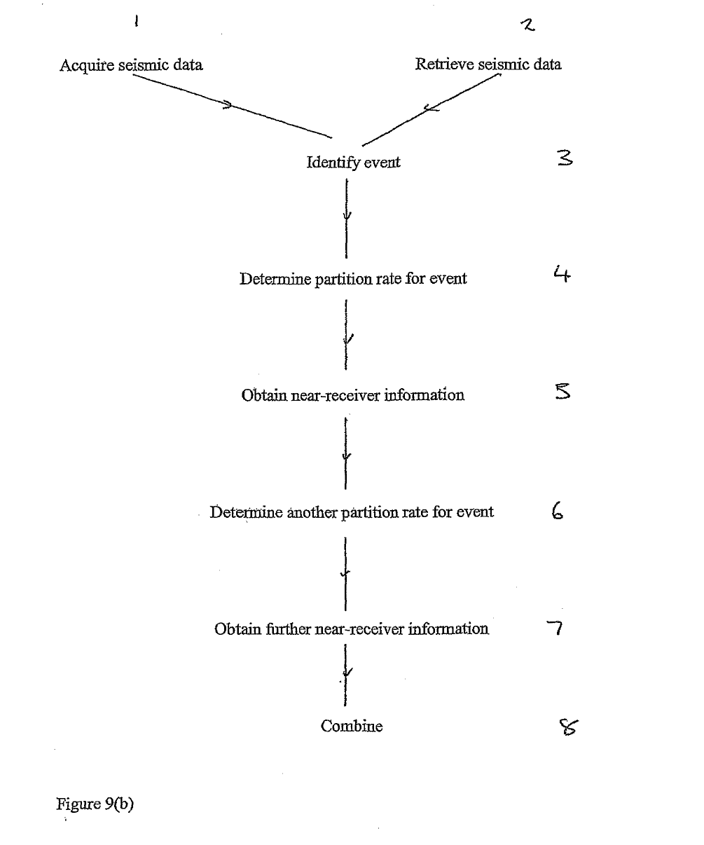

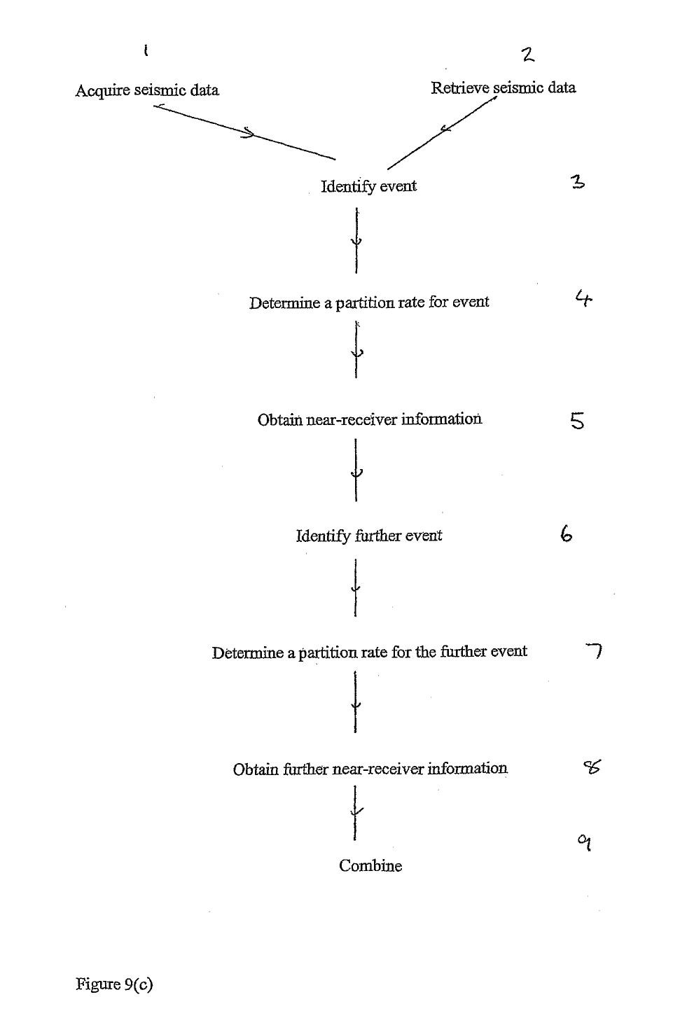

FIG. 9(a) illustrates the principal features of a method according to an embodiment of the invention. At 1 multicomponent seismic data are acquired. Alternatively the method may be performed on pre-existing data, in which case at 2 multicomponent seismic data are retrieved from storage.

At 3 an event is identified in the seismic data, for a particular receiver location. Since the seismic data are multicomponent seismic data, the event will appear in two or more components of the seismic data such as, for example, in the X-component (in-line component) and Z-component (vertical component) of particle motion (and, for some acquisition geometries) also in the Y-component (cross-line component). If the multicomponent seismic data were acquired at receivers disposed on the seabed they may also include pressure data, in which case the event may also occur on the pressure component of the data.

At 4 a partition rate is determined for the event. The partition rate is determined locally, in the time-offset domain. The partition rate may be defined as the ratio of the amplitude of the event as recorded in one component of the data to the amplitude of the event as recorded in another component of the data. For example one partition rate that may be used is the partition rate between the event as recorded in the X-component of the data and the event as recorded in the Z-component of the data (which is known as the “polarisation angle”). If the multicomponent seismic data were acquired at receivers disposed on the seabed the partition rate may alternatively involve the amplitude of the event as recorded in the pressure-component of the data, such as the partition rate between the event as recorded in the X-component (or Z-component) of the data and the event as recorded in the pressure-component of the data.

At 5, information is obtained about the near-receiver properties of the earth from the determined partition rate. How this may be done is described in more detail below but, in summary, the information about the near-receiver properties of the earth may include information about one or more of the near-surface S-wave velocity, the near-surface P-wave velocity and, in the case of data acquired at receivers disposed on/in the seafloor, the density of the earth immediately below the seafloor.

FIG. 9(b) illustrates the principal features of a method according to a further embodiment of the invention. Features 1 to 5 correspond to features 1 to 5 of FIG. 9(a), and their description will not be repeated.

At 6, another partition rate is determined for the event identified at 3, for the same receiver location. Where an event is recorded on three or more components of the seismic data it is possible to define at least three different partition rates. Thus, if for example the partition rate determined at 4 was the partition rate between the event recorded in the X-component of the data and the event as recorded in the Z-component of the data, the partition rate determined at 6 may be the partition rate between the event as recorded in the X-component (or Z-component) of the data and the event as recorded in the pressure-component of the data.

At 7, further information about the near-receiver properties of the earth is obtained from the further partition rate determined at 6. As explained below, the information about the near-receiver properties of the earth obtained from a partition rate depend on the partition rate (and on the type of event), so that the information about the near-receiver properties of the earth obtained at 7 may be different from the information about near-receiver properties of the earth obtained at 5.

At 8, the information about the near-receiver properties of the earth obtained at 7 may optionally be combined with the information about near-receiver properties of the earth obtained at 5. This is possible because the two sets of the information are derived from the same event, and for the same receiver location. This combination may allow further information about the near-receiver properties to be extracted. For example, some partition rates do not provide information about a single parameter of the earth's properties, but instead provide information about two or more parameters o the earth's properties in combination. If information obtained from two different partition rates is combined, this may allow information about one parameter of the earth's properties to be extracted. data, in which case at 2 multicomponent seismic data are retrieved from storage.

If desired, one or more further partition rates may be determined for the event, and 7 and optionally 8 may be repeated for each further event.

FIG. 9(c) illustrates the principal features of a method according to a further embodiment of the invention. Features 1 to 5 correspond to features 1 to 5 of FIG. 9(a), and their description will not be repeated.

At 6, at least one further event is identified in the seismic data, for the same receiver location at the first event. At 7 a partition rate is determined for the event(s) identified at 6. This may be the same partition rate as 4, or in principle it may be a different partition rate.

At 8, further information about the near-receiver properties of the earth is obtained from the partition rate(s) determined at 7 for the further event(s).

At 9, the information about the near-receiver properties of the earth obtained at 7 may optionally be combined with the information about near-receiver properties of the earth obtained at 5. This is possible because the sets of the information are derived from events for the same receiver location.

The method of FIG. 9(c) may be embodied in various ways. For example, the same type of event (eg a P-event) may be selected at 6 as at 3, and the same partition rate may be determined for each event. In this case, the two events should yield the same information about the near-receiver properties, and this allows an averaging process to be applied or provides redundancy of data.

Additionally or alternatively, a different type of event may be selected at 6 than was selected at 3 (eg a P-event may be selected at 3 and an S-event may be selected at 6). In this case the two event may potentially yield different information about the earth's properties, and the two sets of information may be combined as described with reference to feature 8 of FIG. 9(b).

It should be noted that the embodiments of FIGS. 9(b) and 9(c) may be combined, so that information about near-receiver properties is derived from two or more partition rates for two or more events for the same receiver location.

The methods of FIGS. 9(a) to 9(c) may be repeated for different receiver locations. This allows a profile of near-receiver properties to be obtained.

As described below, the obtained information about near-receiver properties may be frequency dependent. Thus, a method of the invention as shown in one of FIGS. 9(a) to 9(c) may be repeated at two or more different frequencies.

Embodiments of the invention will now be described in detail. These embodiments are described with reference to use of the polarisation angle as the partition rate, but this is for convenience and, as mentioned above, partition rates that involve the pressure component may also be used.

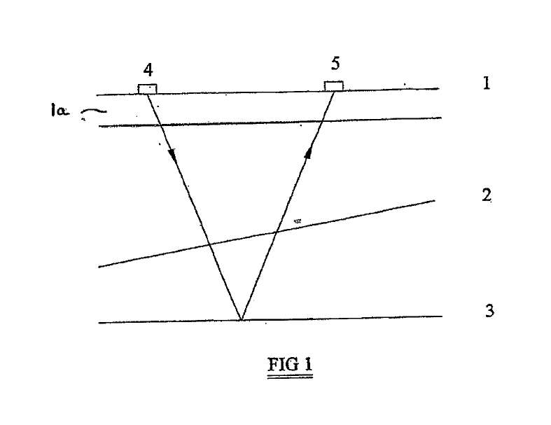

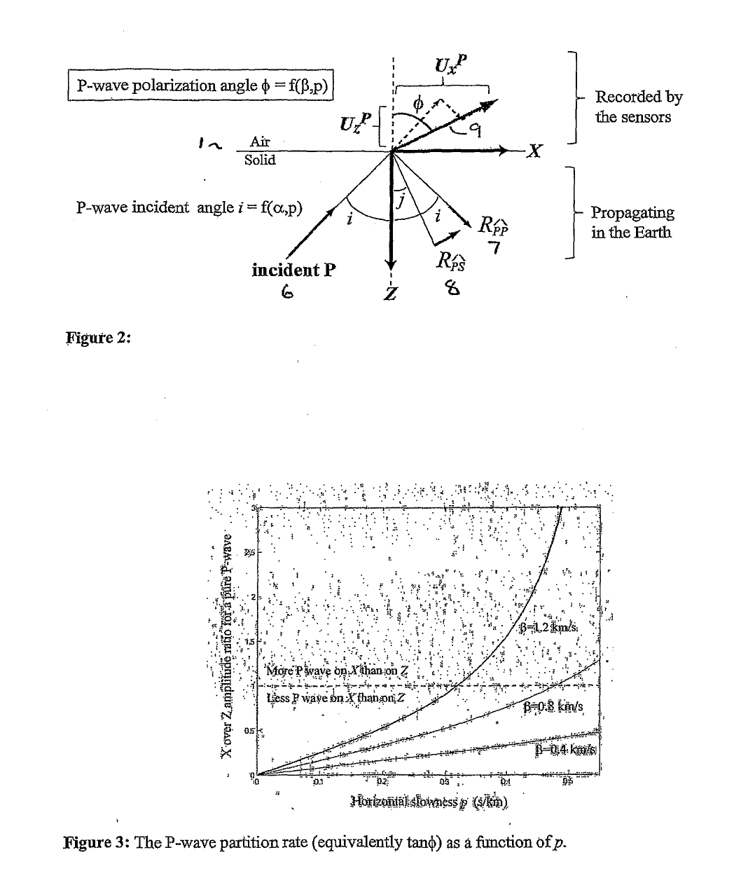

FIG. 2 illustrates a P-wave 6 travelling upwards within the earth (for example corresponding to the upwards path in FIG. 1 from the reflector 3 to the receiver 5). As indicated in FIG. 2, when the P-wave reaches the earth's surface 1 (which constitutes an air-solid interface) it undergoes partial reflection to give a downwardly directed P-wave component 7. Also, the P-wave 6 may undergo partial reflection with mode-conversion, to give a downwardly directed S-wave component 8. A three component (“3C”) sensor disposed on the earth's surface 1 records the particle displacement just below the free surface, so that the components recorded by the sensor contain not only the impinging P-wave 6, but also contain the additional contribution of the P- and PS-waves 7,8 that are reflected downward at the solid-air interface formed by the earth's surface.

In the following analysis, the medium the impinging wave 6 is travelling in is considered to be elastic and isotropic, and the horizontal and vertical components of particle motion in the medium just below the free surface 1 are defined as X and Z in Cartesian coordinates, with Z positive being downward.

In accordance with the analysis described above, considering an incoming P-wave 6 with an incident angle i, the portions of the P-wavefield recorded by a 3-C sensor disposed at the earth's surface along the Z and X axes (respectively) is given by:

U_{z}^{P}=(−q_{α}α+R_{\acute{P}\grave{P}}q_{α}α−R_{\acute{P}\grave{S}}pβ)U_{\grave{P}\acute{P}}

Uₓ^{P=}(pα+R_{\acute{P}\grave{P}}pα+R_{\acute{P}\grave{S}}q_{β}β)U_{\grave{P}\acute{P}} (1)

where α and β are the near-surface P- and S-wave velocities and p is the horizontal slowness. The horizontal slowness p is also known as the “ray parameter” (of an event), and is equal to the inverse of the apparent velocity. (The P- and S-wave velocities are likely to vary with depth within the earth, owing to changes in geological conditions/structure; the terms near-surface P- and S-wave velocities refer to the velocity of P- and S-waves in the near-surface layer of the earth (for example the layer 1a of FIG. 1). The horizontal slowness for P-waves is given by p=sin i/α and the horizontal slowness for S-waves is given by p=sin j/β. The mode-converted S component 8 will have the same horizontal slowness as the original upwards P-wave 6, so sin i/α=sin j/β. The vertical slownesses for P- and S-waves are q_{α}=(α⁻²−p²)^{0.5} and q_{β}=(β⁻²−p²)^{0.5} respectively.

The expressions for the reflection-conversion coefficients are given by:

$${R}_{{P}^{′} {P}^{‵}} = \frac{- {( {β}^{- 2} - 2 {p}^{2} )}^{2} + 4 {p}^{2} {q}_{α} {q}_{β}}{{( {β}^{- 2} - 2 {p}^{2} )}^{2} + 4 {p}^{2} {q}_{α} {q}_{β}} \\ {R}_{{P}^{′} {S}^{‵}} = \frac{4 ( α / β ) {pq}_{α} ( {β}^{- 2} - 2 {p}^{2} )}{{( {β}^{- 2} - 2 {p}^{2} )}^{2} + 4 {p}^{2} {q}_{α} {q}_{β}} \qquad ( 2 )$$

Substituting the expressions for the reflection coefficients into equations (1) provides the following expressions:

$${U}_{z}^{P} = - \frac{2 {q}_{α} α {β}^{- 2} ( {β}^{- 2} - 2 {p}^{2} )}{{( {β}^{- 2} - 2 {p}^{2} )}^{2} + 4 {p}^{2} {q}_{α} {q}_{β}} {U}_{{P}^{‵} {P}^{′}} \\ {U}_{x}^{P} = - \frac{4 {q}_{α} p α {β}^{- 2} {q}_{β}}{{( {β}^{- 2} - 2 {p}^{2} )}^{2} + 4 {p}^{2} {q}_{α} {q}_{β}} {U}_{{P}^{‵} {P}^{′}} \qquad ( 3 )$$

The above equations are valid for a given value of slowness p, i.e. for a given incident angle i of the original upwards P-wave 6. Note that the amount of P-wave energy recorded on the components depends on both the velocities α and β. However, the inventors have determined in their component analysis of the P and S waves at the near surface, with the inclusion of reflection effects on the impinging waves, that for a given value of the horizontal slowness p the polarization angle φ (alternatively the ratio between the P-wave amplitude recorded on the X component and the P-wave amplitude recorded on the Z component) is dependent only on the S-wave velocity β, and is not dependent on the P-wave velocity α, as shown below:

$$tan φ = \vert \frac{{U}_{x}^{P}}{{U}_{z}^{P}} \vert = \vert \frac{2 {pq}_{β}}{{β}^{- 2} - 2 {p}^{2}} \vert \qquad ( 4 )$$

This finding is not intuitive since, despite the fact that for a given slowness the P-wave incident angle is fully controlled by the near-surface P-wave velocity α according to Snell's law the P-wave polarization angle depends solely on the near-surface S-wave velocity β. FIG. 2 shows that in the scenario described above, the polarization angle differs from the incident angle.

The polarisation angle is given by the angle to the vertical made by the vector 9. The vector 9 (which is actually recorded by the 3-C sensor) is the sum of the polarisation vectors shown in FIG. 2 associated with the original upwards P-wave 6, the reflected P-wave 7 and the reflected, mode-converted S-wave 8 (really propagating in the Earth). It can be seen that the polarisation vector R_{P̂S} shown in FIG. 2 associated with the reflected, mode-converted S-wave 8 is orthogonal to the direction of propagation of the reflected, mode-converted S-wave 8 whereas the polarisation vectors shown in FIG. 2 associated with the original upwards P-wave 6 and the reflected P-wave 7 (R_{P̂P}) are parallel to the direction of propagation of with the original upwards P-wave 6 and the reflected P-wave 7 respectively. This is because S-waves are transversely polarised whereas P-waves are longitudinally polarised. (It should be noted that it is the overall polarisation vector 9 that is recorded by a multicomponent sensor, with the X-component and Z-component of the polarisation vector 9 being recorded separately by the multicomponent sensor.)

FIG. 3 shows the tangent of the polarisation angle (tan φ) plotted as a function of horizontal slowness p, for three values of the S-wave velocity β at the earth's surface. FIG. 3 shows that tan φ increases when the near-surface S-wave velocity β increases, for a fixed p. Tan φ is equivalent to the “P wave partition rate” (between the X- and Z-axes), as a value of tan φ>1 indicates that more of the P wave is recorded on the X-component than on the Z-component whereas a value of tan φ<1 indicates that more of the P wave is recorded on the Z-component than on the X-component. The higher the near-surface S-wave velocity β, the higher the amount of P-wave on X (relative to the Z component) for a given value of p. For quite high near-surface S-wave velocities, and for large p values, the amount of the P-wave recorded on the X-component can be much bigger than on the Z component.

The realisation by the present inventors that, for a given slowness, the polarisation angle φ is dependent on the near-surface S-wave velocity β, makes possible improved measurements of the near-surface S-wave velocity β. For example, in accordance with one embodiment of the present invention, a measured P-wave polarization angle at a receiver can be used to determine the near-surface S-wave velocity at the given receiver location.

In one embodiment of the present invention, as soon as a pure P-event of known horizontal slowness p is extracted from the data, the S-wave velocity β just below the earth's surface at each given receiver location can be obtained from the polarization angle φ using the following equation, obtained from equation (4):

$$β = \sqrt{\frac{1 - {( 1 + {tan}^{2} φ )}^{- \frac{1}{2}}}{2 {p}^{2}}} \qquad ( 5 )$$

Since the near-surface S-wave velocity β at each given receiver location can be obtained, this allows a horizontal profile of the near-surface S-wave velocity β to be built up.

Equation (5) was derived for the case of a solid-air interface, as shown in FIG. 2. This corresponds to a sensor disposed on/in a land surface. In the case of a sensor disposed on/in the seabed, the sensor is disposed at a solid-liquid interface rather than a solid-air interface. It can be shown that in this situation a similar result holds, with the P-wave polarisation angle being a function of the S-wave velocity β immediately below the sea-floor, the horizontal slowness, and the density of the earth just below the sea-floor. Thus, in this case also, measurement of the polarisation angle for a P-wave event of known horizontal slowness again allows the near-seafloor S-wave velocity to be determined, provided that the density of the earth just below the sea-floor is known. Alternatively, if the density is unknown measurement of the polarisation angle for a P-wave event of known horizontal slowness again allows information about the near-receiver properties of the earth to be obtained as it allows information about, in combination, the near-seafloor S-wave velocity and the density of the earth just below the sea-floor to be determined (even if neither the near-seafloor S-wave velocity nor the density of the earth just below the sea-floor can individually be determined).

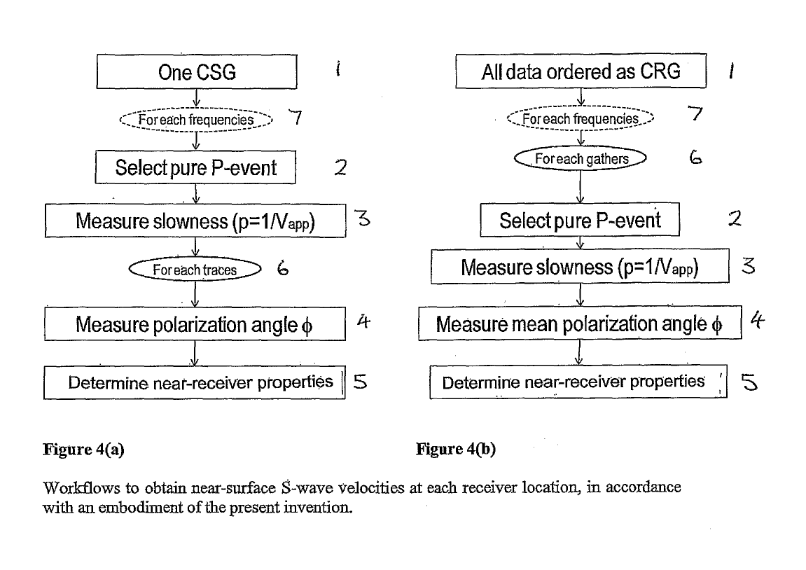

FIG. 4(a) is a block schematic flow diagram of a method according to one embodiment of the present invention. Initially (not shown), seismic data are acquired at one or more multi-component receivers able to record at least X- and Z-components of particle motion, with the receivers deployed at different locations from one another. In general, a source is fired repeatedly in a seismic survey thereby generating a plurality of “shots”, with each shot generating a corresponding record at each receiver. In the case of a multi-component receiver the record includes a trace for each component sensed by the receiver, and the present invention assumes that the or each multi-component receivers can record traces for at least the X- and Z-components of particle motion.

In the embodiment of FIG. 4(a) the acquired traces are sorted to give “common shot gathers”, where a common shot gathers is a gather of records acquired for one shot of the source (and so includes records obtained at different receivers). Alternatively, the method may be performed on pre-existing seismic traces, in which case pre-existing traces are retrieved from storage and, if necessary, sorted into common shot gathers.

At step 1 of FIG. 4(a), one common shot gather is selected. At step 2, a pure P-event is identified in the traces of the selected common shot gather. A “pure P-event” is an event in which the seismic energy incident on the receiver contains only P-waves and does not contain S-waves. The selection of the pure P-event may be achieved by automatic tracking (especially for the “first break” event in the traces), and/or may be done manually. For example, one exemplary method of selecting a pure P-event is to apply a time window which is expected to contain only pure P-events to the traces, and look for events in that time window while disregarding events outside the time window. Optionally, the length of the time-window may be adjusted as a function of the source frequency.

At step 3, the horizontal slowness p of the selected pure P-event is determined. The slowness, and thus also the horizontal slowness, is frequency-dependent for wave propagation in a dispersive medium such as the earth. Step 3 therefore obtains the horizontal slowness of the selected pure-P event for a specific frequency of seismic energy. In some embodiments of the present invention, the horizontal slowness may be derived from the apparent velocity of the pure P-event.

It should be noted that the invention is not limited to performing steps 2 and 3 in the order shown in FIG. 4(a), that is identifying a pure P-event and then determining the horizontal slowness. In principle, steps 2 and 3 could be replaced by any step, or combination of steps, that lead to the identification of at least one P-event of know horizontal slowness. For instance, a technique based on velocity discrimination in the f-k (frequency-wavenumber) domain or tau-p (intercept time-horizontal slowness) domain, for example a technique such as, for example, dip filtering (for example f-k filtering) may be applied to extract one or more events of a given horizontal slowness. Since P- and S-waves can sometimes have similar slowness to one another, it may then be necessary to determine which of the extracted events of the given horizontal slowness are P-events. This may be done by, for example, applying a time window in which only P-events are expected to arrive and discarding any extracted events that are outside this time window.

At step 4, the polarisation angle of the selected P-event is determined for one receiver location, from the traces for the X-component and Z-component of particle motion acquired at that receiver.

At step 5, the determined polarisation angle is used, with the horizontal slowness for the event as determined at step 3, to obtain information about the near-receiver properties of the earth. In an embodiment where the seismic data are land seismic data step 5 may for example comprise calculating the near-surface S-wave velocity at the receiver location, for example according to equation (5). In an embodiment where the seismic data were acquired at sea-floor receivers, and the density of the earth just below the seafloor is known, step 5 may again comprise calculating the near-surface S-wave velocity at the receiver location. In an embodiment where the seismic data were acquired at sea-floor receivers, and the density of the earth just below the seafloor is not known, step 5 may comprise obtaining information about the near-surface S-wave velocity and the density of the earth just below the seafloor in combination (although, unless further information is available, neither the near-surface S-wave velocity nor the density can be individually determined).

Steps 4 and 5 may then be repeated for another receiver location, by using the traces for the X-component and Z-component of particle motion acquired at the next receiver location to determine the polarisation angle of the selected P-event for the next receiver location, and using this to calculate the near-surface S-wave velocity at the receiver location. By repeating steps 4 and 5 for further receiver locations, and preferably for all receiver locations as schematically indicated by the loop 6, a profile of the information about the near-surface, for example a profile of the near-surface S-wave velocity, can be built up.

If desired, it is possible to repeat step 3 by determining the horizontal slowness p at another frequency, and then to repeat steps 4 and 5 to obtain information about the near-surface, for example the S-wave velocity, at the new frequency. As noted, this may be done for more than one, and preferably all, receiver locations, to obtain a profile of the information about the near-surface, for example a profile of the near-surface S-wave velocity, at the new frequency. This process may be repeated for one or more other frequencies.

The method may be carried out for multiple P-events of known horizontal slowness (and where two or more P-events have the same horizontal slowness, the method may be performed for these P-events simultaneously). Where the method is performed on two or more events acquired at the same receiver, the same results should be obtained for all events, since all events should give the near-receiver properties at one receiver location. Thus, performing the method for two or more events provides redundancy, or allows the results to be averaged to provide a more accurate results.

For an event, the method may be carried out at one or more different frequencies. In principle, all events acquired at a particular location should give the same information about the near-receiver properties—for example in an embodiment which determines the near-surface S-wave velocity all events acquired at a particular location should give the same value of the near-surface S-wave velocity, since all events acquired at a particular location should give the value of the near-surface S-wave velocity for that location. In practice, however, lower frequencies “see” deeper into the earth, whereas high frequencies “see” only a very short way into the earth, so that, for a particular location, carrying out the method at a low frequency is likely to give a different value for the S-wave velocity than carrying out the method at a higher frequency—because performing the method at a low frequency and performing the method at a high frequency are effectively measuring the S-wave velocity at different depths within the earth.

Thus far, a single common shot gather has been analyzed, and may be used to characterize the whole receiver line. If desired, the method of FIG. 4(a) may be repeated for another common shot gather, by selecting another common shot gather and repeating steps 2-5, and optionally step 6 and/or step 7, for the new gather; this process may be further repeated for one or more further gathers.

FIG. 4(b) shows a method according to another embodiment of the invention. In the embodiment of FIG. 4(b) the acquired traces are sorted to give “common receiver gathers”, where a common receiver gather is a gather of records acquired at one receiver and which includes records obtained for different shots of the source. Alternatively, the method may be performed on pre-existing seismic traces, in which case pre-existing traces are retrieved from storage and, if necessary, sorted into common receiver gathers.

At step 1 of FIG. 4(a), one common receiver gather is selected. At step 2, a pure P-event is identified in the traces of the selected common receiver gather, and at step 3 the horizontal slowness (for a particular frequency) of this pure P-event is determined. Steps 2 and 3 correspond generally to steps 2 and 3 of FIG. 4(a), and their description will not be repeated (except to note that, as explained with reference to FIG. 4(a), they may be replaced by any step or combination of steps that leads to the identification of a P-event with known horizontal slowness).

As noted above, the common receiver gather contains records acquired at one receiver, for a plurality of different shots. At step 4 of FIG. 4(b), the average polarisation angle for the selected pure P-event is determined, by determining the polarisation angle of the selected event for two or more records of the common receiver gather (and preferably for all records of the gather, provided that the selected pure P-event is well-recorded in each record), and taking the average of the various values for the polarisation angle of the event.

At step 5, the average polarisation angle is used, with the horizontal slowness for the event as determined at step 3, to determine information about near-receiver properties of the earth. As explained with reference to FIG. 4(a), step 5 may for example comprise calculating the near-surface S-wave velocity at the receiver location (for land data, or for data acquired at sea-floor receivers if the density is known), or may comprise obtaining information about the near-surface S-wave velocity and the density in combination (for data acquired at sea-floor receivers if the density is not known).

The polarization angle of the selected P-event should be constant for all the traces of the common receiver gather. Thus, the method of FIG. 4(b) may be more robust than the method of FIG. 4(a) because more traces (and potentially the records acquired at one receiver for all shots) may be used to determine the near-surface S-wave velocity at a given receiver position (instead of using only one trace in the common-shot domain embodiment of FIG. 4(a)).

Steps 2 to 5 may then be repeated for one or more further common receiver gathers, and preferably for all the common receiver gathers, as shown by loop 6. By repeating steps 2 to 5 for further receiver locations, and preferably for all receiver locations, a profile of the near-surface S-wave velocity can be built up.

Steps 2-5 may additionally or alternatively be repeated for one or more other frequencies, as shown schematically by loop 7.

If the seismic data contain two or more pure P-events, the method of FIG. 4(a) or 4(b) may be repeated for one or more other pure P-events.

As noted above, the invention may be used to determine the near surface S-wave velocity as a function of frequency. In a further embodiment, the present invention may be used in/applied to a frequency-dependent analysis to determine the near surface S-wave velocity as a function of frequency as well as of receiver location (in the common-shot or the common-receiver domain). The measured P-wave polarization angles may be converted into S-wave velocities for each frequency independently. In such embodiments of the present invention, a pseudo-depth image of the near-surface S-wave velocity structure may be determined—this image may be 1D, 2D or 3D depending on the receiver distribution.

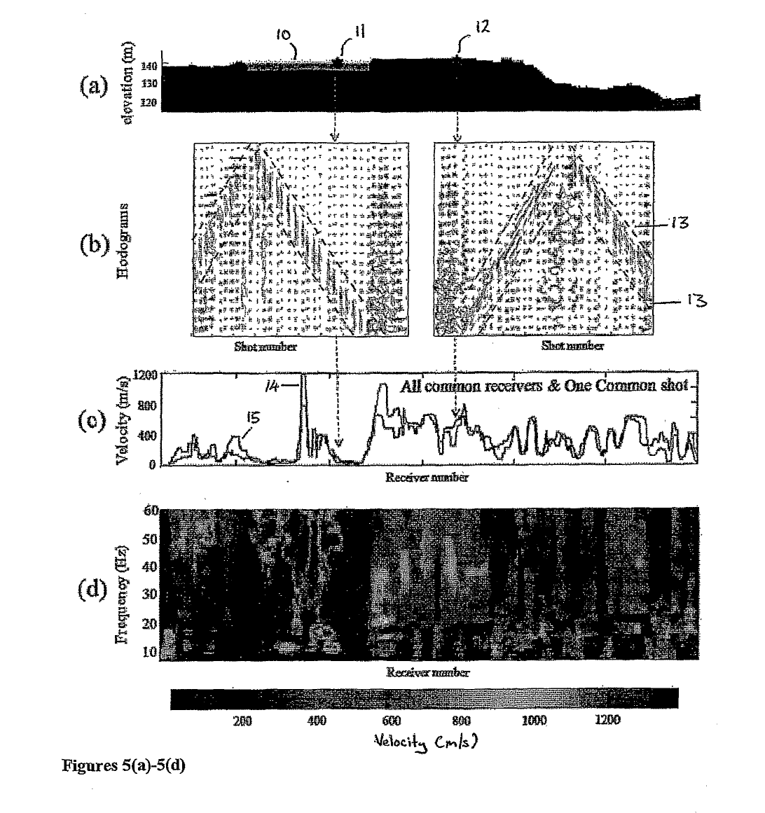

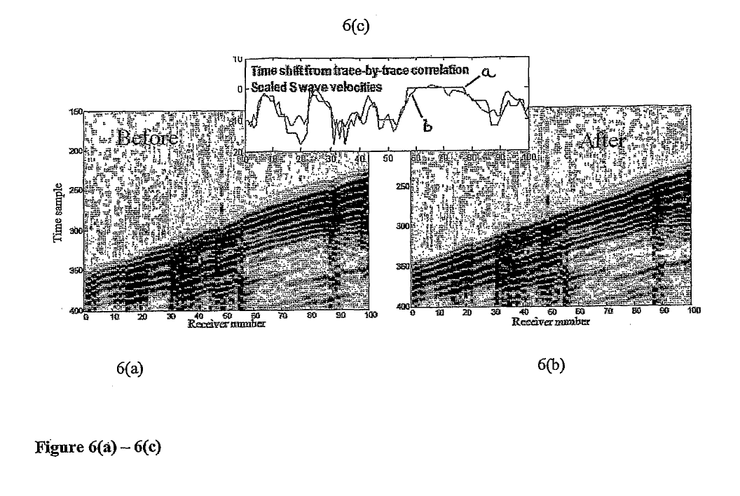

FIGS. 5(a)-5(d) and 6(a)-(b) illustrate results obtained by the method of the invention. These figures illustrate the results of applying an embodiment of the present invention on a field dataset acquired in an arctic environment. Such data are notorious for difficult near-surface conditions (for example the presence of frozen and thaw zones), which may lead to strong static shift problems as well as specific ice-related noise.

In the field test of an embodiment of the present invention, data were acquired using receivers deployed in a 2D line approximately 3 km long, partially deployed on a frozen lake 10 (see FIG. 5(a), which is a cross-section through the test site). The interval between the point-receivers (3C accelerometers) was 5 meters. The test site is located in slightly undulating area (between 120 and 140 meters of elevation above sea level, as shown in FIG. 5(a)). The water bodies are covered with ice and probably contain unfrozen water. We expect to see large lateral variation of the elastic properties near the surface because of the different frozen zones and thaw zones which form high velocity zones and low velocity zones respectively.

FIG. 5(b) shows the hodograms (Z vs. X components of particle motion) for two different common-receiver gathers. The left hodogram in FIG. 5(b) is for a receiver located on the frozen lake at position 11 in FIG. 5(a); the right hodogram in FIG. 5(b) is for a receiver located off the lake at position 12 in FIG. 5(b). The main features show the polarization of the first break (between the dashed lines 13), which is a refracted wave of known horizontal slowness (p=Vₐₚₚ⁻¹, where the apparent velocity Vₐₚₚ=2 km/s here). The length of the time window defined by the dashed lines is 200 ms.

An example of a pseudo-depth image is shown in FIG. 5(d). This figure is described more fully below but in brief the horizontal axis of FIG. 5(d) represents receiver number, the vertical scale of FIG. 5(d) represents frequency, and the shading denotes the magnitude of the S-wave velocity at a particular receiver number and frequency. FIG. 5(d) was acquired using receivers arranged along a line.

In such a pseudo-depth image, high frequencies (small wavelengths) are more sensitive to the very near-surface properties than the low frequencies (longer wavelengths). The frequency-dependence of the polarization angles (and hence the frequency dependence of the S-wave velocities) emphasizes depth-varying near-surface conditions, for example arising from surface weathering (see, for example, Hanson et al., 1993)—so that the image of FIG. 5(d) may be considered as a pseudo-depth image.

As explained above, the S-wave velocity at a receiver position may be found from the P-wave polarisation angle measured at that receiver. FIG. 5(c) shows the (frequency independent) near-surface S-wave velocity profile obtained from the P-wave polarisation angle for all common-receiver gathers (14, in blue) and also for one given common-shot gather (15, in red). The S-wave velocity was obtained using the method of FIG. 4(b) and the method of FIG. 4(a) respectively. The horizontal scale of FIG. 5(c) is the same as the horizontal scale of FIG. 5(a). The excellent agreement between the two profiles demonstrates the robustness of the embodiment of the present invention.

FIG. 5(c) shows strong S-wave velocity lateral variations from 100 m/s to 1000 m/s off the lake 8, highlighting the presence of fast-frozen and slow-thaw zones at the earth's surface (presumably below water bodies like rivers). In contrast, we observe very low near-surface velocities on lake side. S-waves in pure ice are relatively fast (with a velocity of around 1800 m/s) but FIG. 5(c) shows a mean velocity of approximately 50 m/s on the lake side. This is due to the dominant frequency (around 30 Hz) of the P-event being insensitive to the thin ice layer (around one meter thick).

FIG. 5(d) shows the pseudo-depth S-wave velocity structure obtained from frequency-dependent analysis in the common-receiver domain. The horizontal axis of FIG. 5(d) shows receiver number, and has the same horizontal scale as FIGS. 5(a) and 5(c). The vertical scale of FIG. 5(d) represents P-wave frequency. The shading denotes the magnitude of the S-wave velocity estimated from the P-wave at this frequency, as indicated in the key below the figure (the horizontal axis of which is the estimated near-surface S-wave velocity in m/s). It can be seen that the ice layer over the frozen lake 10, which is expected to have a high S-wave velocity, is detected by the high frequencies (a velocity of around 1200 m/s above 40 Hz) while the lower frequencies highlight the presence of deeper water and mushy materials across the lake.

Near-surface characterization of the S-wave velocity in accordance with embodiments of the present invention may be used in further processing of the acquired multicomponent data (or in the processing of other seismic data acquired at the survey location), for example to obtain information about one or more parameters of the earth's interior and/or to locate or characterise hydrocarbon deposits. The obtained information about the near-surface S-wave velocity may for example be used for one or more of noise characterization, depth imaging, P-S wavefield separation and/or correction for the static shift caused by a laterally-heterogeneous surface or near-surface layer, such as layer 1a of FIG. 1.

This last use of information about the near-surface S-wave velocity obtained by an embodiment of the present invention, namely correction for the static shift, is illustrated in FIGS. 6(a) to 6(c). FIG. 6(c) shows Z-component traces acquired at 100 receivers, with each trace shown as a function of time after actuation of the source (vertical axis), with the amplitude indicated by shading. The traces were acquired at 100 receivers arranged in a 1-D array, and are arranged in order of the receiver number (horizontal axis). It would be expected that the time at which an event occurs would vary smoothly with receiver number (assuming regular spacing of receivers), as a result of the varying source-receiver distance. As FIG. 6(a) shows, however, the arrival time of an event does not always vary smoothly with receiver number (as seen, for example, by the sharp changes in arrival time at around receiver Nos. 22 and 30), and this is a consequence of static shifts caused by a low velocity layer such as the layer 1a of FIG. 1.

One known method for correcting for static shifts is to use “event tracking”, in which a particular event is tracked through the traces using trace-to-trace correlation. FIG. 6(b) corresponds to FIG. 6(a), but shows the traces after they have been corrected for the static shift using an event tracking method. As can be seen, the arrival times of events in the traces varies much more smoothly with receiver number in FIG. 6(b) than in FIG. 6(a).

FIG. 6(c) shows, as trace a (blue), the time shift to be applied to each of the traces of FIG. 6(a) to correct for the static shift, as determined by the event tracking method used to generate the traces of FIG. 6(b). The magnitude of the time shift is shown by the left hand vertical scale of FIG. 6(c), and the horizontal scale of FIG. 6(c) is the same as the horizontal scale of FIGS. 6(a) and 6(b). FIG. 6(c) also shows, as trace b (red), the scaled near surface S-wave velocity determined for each receiver location using a method of the invention. (The S-wave velocity profile has been scaled in the vertical direction for visual purposes, to emphasise the correlation between the S-wave velocity and the time shift.) It can be seen that there is a very good correlation between the near surface S-wave velocity at a receiver location and the time shift required to correct for the static shift in a trace acquired at that receiver. This result demonstrates the reliability of embodiment the present invention and also suggests that near-surface P-wave velocity and S-wave velocity lateral variation are closely related in this example. Analysis performed on synthetic seismic data generated for an earth structure model having a laterally-heterogeneous near surface layer verify these conclusions.

The results of FIG. 6(c) show that the near surface S-wave velocity determined by a method of the invention may be used to correct acquired traces for the static shift caused by an heterogeneous near surface layer. In essence, a trace may be corrected by determining the near surface S-wave velocity for the location of the receiver used to acquire the trace, and determining the required time shift from the near surface S-wave velocity.

The embodiments of FIGS. 4(a) and 4(b) relate to the determination of near-receiver properties, such as the near surface S-wave velocity from a P-event, using the horizontal slowness of a pure P-event and the polarisation angle of the P-event. The invention is not however limited to this and may also be applied to the determination of the near-receiver properties from an S-event. From an analysis similar to that leading to equation (5) it can be shown that for an S-event at a solid-air boundary, the polarisation angle tan ψ of the S-event is given by:

$$\begin{matrix}\frac{{U}_{z}^{S}}{{U}_{x}^{S}} = tan ψ = \frac{2 {pq}_{α}}{{β}^{- 2} - 2 {p}^{2}} \\ where \text{:} & ( 6 ) \\ {q}_{α} = \sqrt{{α}^{- 2 \cdot } - {p}^{2}} , & ( 7 ) \\ {q}_{β} = \sqrt{{β}^{- 2} - {p}^{2}} , & ( 8 )\end{matrix}$$

and α is the near-receiver P-wave velocity and p is the horizontal slowness of the S-event. Thus, equation (6) may be inverted to obtain information about the near-surface S-wave velocity and the near-surface P-wave velocity in combination, one the S-wave polarisation angle and horizontal slowness are determined.

Thus if the near-surface S-wave velocity at a receiver location is known (for example from a method of the invention as described above), the near-surface P-wave velocity at that receiver location may be found by combining the near-surface S-wave velocity with the information about the near-surface S-wave velocity and the near-surface P-wave velocity in combination inverted from the measured polarization angle(s) of any pure S-wave event(s) (of known horizontal slowness) acquired at that receiver location—ie, it is possible to obtain near-receiver information that comprises information about the near-surface P-wave velocity. Alternatively, if the near-surface S-wave velocity at the receiver location is not known it is possible to obtain near-receiver information that comprises information about the near-surface S-wave velocity and the near-surface P-wave velocity in combination (although neither the near-surface S-wave velocity nor the near-surface P-wave velocity can be individually determined).

In the case of data acquired at receivers disposed on the seabed, such as OBC receivers, similar equations apply that allow information about near-receiver properties, such as the near-surface S-wave velocity and near surface S-wave velocity (strictly speaking in a case of data acquired at sea-bed receivers information is obtained about the “near-seafloor” S-wave and/or P-wave velocity, but the term “near surface” will be used for convenience) to be obtained from the polarisation angle of P- and S-events. As explained above, in the case of data acquired at sea-bed receivers the polarisation angle for an event is also a function of the density of the earth just below the seafloor.

In the case of an event in data acquired at a receiver disposed on the seabed there are three cases to consider, namely upgoing P-events, downgoing P-event and S-events (which are always upgoing). It can be shown that the polarisation angles of these three types of events are given by:

$$\begin{matrix}tan φ ( upgoing P \text{-} event ) \frac{{U}_{x}^{{P}^{′}}}{{U}_{z}^{{P}^{′}}} = \frac{{M}_{21}}{{M}_{11}} = \frac{p ( {ρ}_{w} + 2 {β}^{2} {q}_{β} ρ {q}_{w} )}{( - 1 + 2 {p}^{2} {β}^{2} ) ρ {q}_{w}} , & ( 9 ) \\ tan φ ( downgoing P \text{-} event ) \begin{matrix}\frac{{U}_{x}^{{P}^{‵}}}{{U}_{z}^{{P}^{‵}}} = \frac{{M}_{23}}{{M}_{13}} \\ = \frac{p ( 1 - 2 {p}^{2} {β}^{2} - 2 {β}^{2} {q}_{α} {q}_{β} )}{{q}_{α}}\end{matrix} & ( 10 ) \\ tan φ ( S \text{-} event ) \frac{{U}_{z}^{{S}^{′}}}{{U}_{x}^{{S}^{′}}} = \frac{{M}_{12}}{{M}_{22}} = \frac{2 {β}^{2} {q}_{α} ρ {pq}_{w}}{( ρ {q}_{w} ( 1 - 2 {p}^{2} {β}^{2} ) + {ρ}_{w} {q}_{α} )} & ( 11 )\end{matrix}$$

In equations (9), (10) and (11), ρ is the density of the earth immediately below the seafloor, α_{w} is the P-wave velocity in water, and q_{w}=(α_{w}⁻²−ρ²)^{1/2}. The P-wave velocity in water and the corresponding vertical slowness are assumed to be know.

It can thus be seen that for the case of OBC data, the polarisation angle of an upgoing P-event and the horizontal slowness of the P-event may be inverted to give information about, in combination, the near-surface S-wave velocity and the density of the earth just below the seafloor. The polarisation angle and horizontal slowness of a downgoing P-event or an S-event (which is always upgoing) may be inverted to give information about, in combination, the near-surface P-wave velocity, the near-surface S-wave velocity and the density of the earth just below the seafloor.

Thus, in the case of seismic data acquired at sea-floor receivers, for an downgoing P-event or an S-event if the density and the near-surface S-wave velocities are not known it is possible to obtain near-receiver information that comprises information about the near-surface S-wave velocity, the near-surface P-wave velocity and the density in combination (although none of the near-surface S-wave velocity, the near-surface P-wave velocity nor the density can be individually determined). If the near-surface S-wave velocity is additionally known, it is possible to obtain near-receiver information that comprises information about the near-surface P-wave velocity and the density, in combination, and if the density is additionally known it is possible to obtain near-receiver information that comprises information about the near-surface P-wave velocity and the near-surface S-wave in combination. If the near-surface S-wave velocity and the density are both known, it is possible to obtain information about the near-surface P-wave velocity. Finally, if the near-surface S-wave velocity and the near-surface P-wave velocity are both known, it is possible to obtain information about the density of the earth just below the seafloor.

Similarly, in the case of an upgoing P-event, in the case of seismic data acquired at sea-floor receivers, it is possible to obtain near-receiver information that comprises information about the near-surface S-wave velocity and the density in combination, although neither the near-surface S-wave velocity nor the density can be individually determined unless further information is available. If the near-surface S-wave velocity is additionally known, it is possible to combine this with the information about the near-surface S-wave velocity and the density in combination to extract information about the density, and if the density is additionally known it is possible to combine this with the information about the near-surface S-wave velocity and the density in combination to extract information about the surface S-wave velocity.

The above discussion has concentrated on the particle motion. However, in the case of data acquired at receivers disposed on/in the seabed it is possible that pressure data may also be available, as multicomponent receivers that can record pressure as well as particle motion are known. In this case, equations (9), (10) and (11) can be extended to include partition between the pressure component and the particle motion components. The partition rates between components are as follows:

The partition rates of upgoing P waves between the components are given by:

$$\frac{{U}_{x}^{{P}^{′}}}{{U}_{z}^{{P}^{′}}} = \frac{{M}_{21}}{{M}_{11}} = \frac{p ( {ρ}_{w} + 2 {β}^{2} {q}_{β} ρ {q}_{w} )}{( - 1 + 2 {p}^{2} {β}^{2} ) ρ {q}_{w}} , \\ \frac{{U}_{z}^{{P}^{′}}}{{U}_{h}^{{P}^{′}}} = \frac{{M}_{11}}{{M}_{31}} = - {q}_{w} {α}_{w} , \\ \frac{{U}_{x}^{{P}^{′}}}{{U}_{h}^{{P}^{′}}} = \frac{{M}_{21}}{{M}_{31}} = \frac{1}{{q}_{w} {α}_{w}} \frac{{M}_{21}}{{M}_{11}} . \qquad ( 12 )$$

The partition rates of downgoing P waves between the components are given by:

$$\frac{{U}_{x}^{{P}^{‵}}}{{U}_{z}^{{P}^{‵}}} = \frac{{M}_{23}}{{M}_{13}} = \frac{p ( 1 - 2 {p}^{2} {β}^{2} - 2 {β}^{2} {q}_{α} {q}_{β} )}{{q}_{α}} , \\ \frac{{U}_{x}^{{P}^{‵}}}{{U}_{h}^{{P}^{‵}}} = \frac{{M}_{23}}{{M}_{33}} = \frac{{α}_{w} {ρ}_{w} p ( 1 - 2 {p}^{2} {β}^{2} - 2 {β}^{2} {q}_{α} {q}_{β} )}{ρ ( 1 - 4 {p}^{2} {β}^{2} + 4 {p}^{4} {β}^{4} + 4 {p}^{2} {q}_{α} {q}_{β} {β}^{4} )} , \\ \frac{{U}_{h}^{{P}^{‵}}}{{U}_{z}^{{P}^{‵}}} = \frac{{M}_{33}}{{M}_{13}} = \frac{ρ ( 1 - 4 {p}^{2} {β}^{2} + 4 {p}^{4} {β}^{4} + 4 {p}^{2} {q}_{α} {q}_{β} {β}^{4} )}{{q}_{α} {ρ}_{w} {α}_{w}} . \qquad ( 13 )$$

The partition rates of upgoing S waves between the components are given by:

$$\frac{{U}_{z}^{{S}^{′}}}{{U}_{x}^{{S}^{′}}} = \frac{{M}_{12}}{{M}_{22}} = \frac{2 {β}^{2} {q}_{α} ρ {pq}_{w}}{( ρ {q}_{w} ( 1 - 2 {p}^{2} {β}^{2} ) + {ρ}_{w} {q}_{α} )} , \\ \frac{{U}_{z}^{{S}^{′}}}{{U}_{h}^{{S}^{′}}} = \frac{{M}_{12}}{{M}_{32}} = - {q}_{ω} {α}_{w} , \\ \frac{{U}_{x}^{{S}^{′}}}{{U}_{h}^{{S}^{′}}} = \frac{{M}_{22}}{{M}_{32}} = - \frac{1}{{q}_{w} {α}_{w}} \frac{{M}_{22}}{{M}_{12}} . \qquad ( 14 )$$

In these equations, Uₓ denotes the amplitude of the X-component of particle motion, U_{z} denotes the amplitude of the Z-component of particle motion, and Uₕ denotes the amplitude of the hydrophone-component (ie pressure).

It can been seen that in each case the first partition rate, namely the Uₓ to U_{z} partition rate is equal to the polarisation angle given in equation (9), (10) or (11) respectively. The partition rate between the X-component of particle motion and Z-component of particle motion is equivalent to the X-Z polarisation angle. Partition rates between the hydrophone component and a particle motion component can be considered as a polarisation angle although, strictly speaking, it is incorrect to use the term “polarisation angle” in connection with a pressure component.

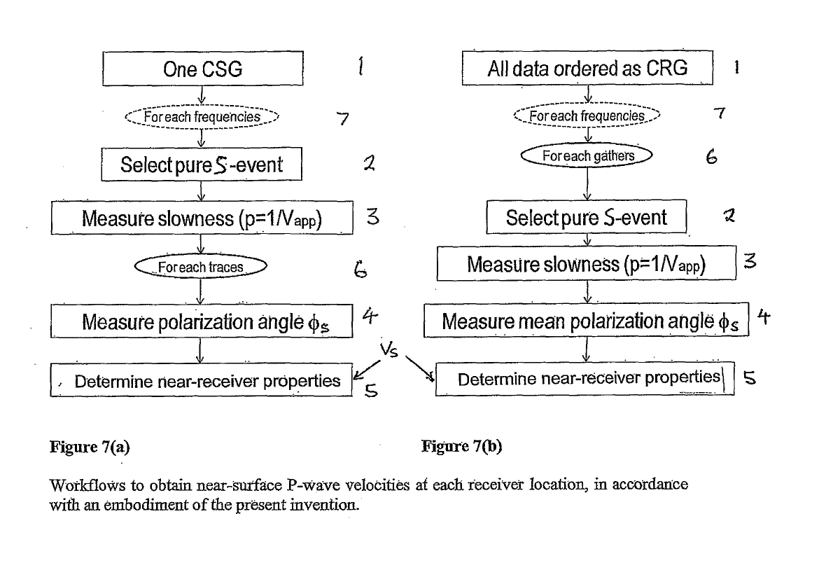

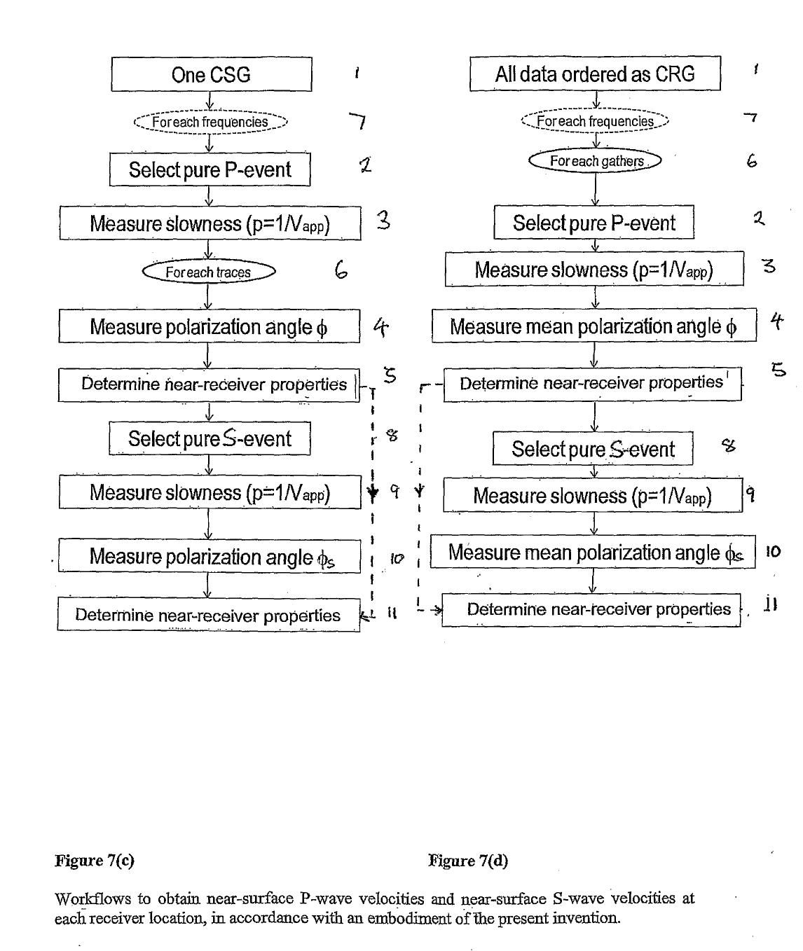

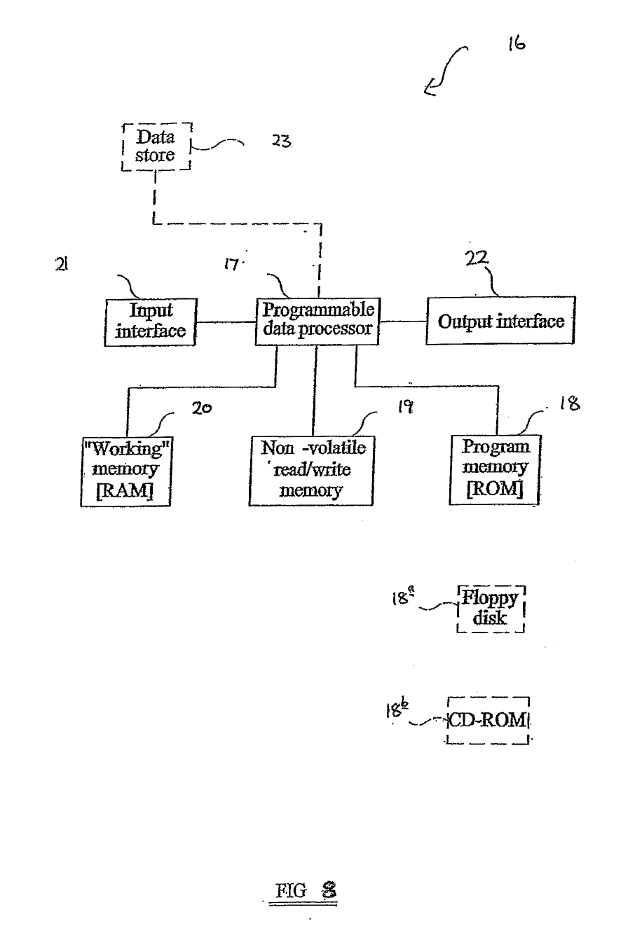

FIG. 7(a) is a block flow diagram illustrating a method of determining near-receiver velocity according to another embodiment of the present invention. Initially (not shown), seismic data are acquired at one or more multi-component receivers able to record at least X- and Z-components of particle motion, with the receivers deployed at different locations from one another. The present invention assumes that the or each multi-component receivers can record traces for at least the X- and Z-components of particle motion.

In the embodiment of FIG. 7(a) the acquired traces are sorted to give “common shot gathers”, where a common shot gathers is a gather of records acquired for one shot of the source (and so includes records obtained at different receivers). Alternatively, the method may be performed on pre-existing seismic traces, in which case pre-existing traces are retrieved from storage and, if necessary, sorted into common shot gathers.

At step 1 of FIG. 7(a), one common shot gather is selected. At step 2, a pure S-event is identified in the traces of the selected common shot gather. A “pure S-event” is an event in which the seismic energy incident on the receiver contains only S-waves and does not contain P-waves. One exemplary method of selecting a pure S-event is to apply a time window which is expected to contain only pure S-events to the traces, and look for events in that time window while disregarding events outside the time window. Optionally, the length of the time-window may be adjusted as a function of the source frequency.

At step 3, the horizontal slowness p of the selected pure S-event is determined. The slowness, and thus also the horizontal slowness, is frequency-dependent for wave propagation in a dispersive medium such as the earth. Step 3 therefore obtains the horizontal slowness of the selected pure-S event for a specific frequency of seismic energy. In some embodiments of the present invention, the horizontal slowness may be derived from the apparent velocity of the pure S-event.

It should be noted that, as explained with reference to FIG. 4(a), the invention is not limited to performing steps 2 and 3 in the order shown in FIG. 7(a), that is identifying a pure S-event and then determining the horizontal slowness. In principle, steps 2 and 3 could be replaced by any step, or combination of steps, that lead to the identification of at least one S-event of known horizontal slowness.

At step 4, the polarisation angle of the selected S-event is determined for one receiver location, from the traces for the X-component and Z-component of particle motion acquired at that receiver.

At step 5, the determined S-event polarisation angle is used, with the horizontal slowness for the event as determined at step 3, to obtain information about the near-receiver properties of the earth. As explained above, the precise information about the near-receiver properties of the earth that can be obtained will depend on what other information is available. For example, if the data are land seismic data, information about the near surface S-wave velocity and the near-surface P-wave velocity combined may be obtained by inverting equation (6). If the near surface S-wave velocity at the receiver location is known (as indicated by the arrow into box 5) this may then be combined with the information about the near surface S-wave velocity and the near-surface P-wave velocity obtained from the S-event polarisation angle and the horizontal slowness, to extract the near-surface P-wave velocity. As another example, if the seismic data were acquired at sea-floor receivers, step 5 may comprises obtaining information about the near surface S-wave velocity, the near-surface P-wave velocity and the density combined by inverting equation (11). If the near surface S-wave velocity at the receiver location is known (as indicated by the arrow into box 5) this may then be combined with the information obtained from the S-event polarisation angle, to extract information about the near-surface P-wave velocity and the density combined. If information about the density is available this may then be used to allow the near-surface P-wave velocity to be extracted; alternatively if information about the near-surface P-wave velocity is available this may then be used to allow the density of the earth just below the seafloor to be extracted.

It can therefore be seen that the method of FIG. 7(a) is similar to the method of FIG. 4(a). However, as explained above, the information about near-receiver properties obtained at step 5 can only provide a determination of the near-surface P-wave velocity if at least the near-surface S-wave velocity is also known, as indicated schematically in FIG. 7(a). S-wave velocity used in the determination of the P-wave velocity at step 5 may, for example be obtained by a method of the invention, such as a method as shown in FIG. 4(a) or FIG. 4(b).

Steps 6 and 7 of FIG. 7(a) correspond to steps 6 and 7 of FIG. 4(a), and their description will not be repeated.

FIG. 7(b) is a block flow diagram illustrating a method of determining the P-wave velocity according to another embodiment of the present invention. The method of FIG. 7(b) is based on the method of FIG. 4(b), but is adapted to the determination of the P-wave velocity as explained with reference to the example of FIG. 7(a). Thus, step 2 of FIG. 7(b) comprises selecting an S-event, step 3 comprises determining the slowness of the selected S-event, step 4 comprises determining the polarisation angle of the selected S-event, and step 5 comprises determining information about the near-receiver properties from at least the determined S-event polarisation angle and the horizontal slowness for the S-event, for example by inverting equation (6) (for data acquired on land) or by inverting equation (11) (for data acquired at receivers disposed on the seabed). As explained with reference to FIG. 7(a) above, the precise information about the near-receiver properties of the earth that can be obtained will depend on what other information is available. Steps 1, 6 and 7 of FIG. 7(b) correspond to steps 1, 6 and 7 of FIG. 4(b), and their description will not be repeated.

FIG. 7(c) is a block flow diagram illustrating a method of determining information about near-receiver properties from both S-wave events and P-wave events according to another embodiment of the present invention. Steps 1 to 7 of FIG. 7(c) correspond to steps 1 to 7 of FIG. 4(a), and steps 8-11 of FIG. 7(c) correspond to steps 2, 3, 4 and 5 of FIG. 7(a), and detailed description of the steps will not be repeated. In the method of FIG. 7(c), if the near-surface S-wave velocity is determined at step 5 this may be used as one input in the determination of the information about the near-receiver properties from the S-wave event at step 11, as indicated by the broken line from step 5 to step 11. Thus, where the seismic data are acquired in a land survey the near-surface P-wave velocity can be obtained at step 11; in the case of seismic data are acquired at sea-floor receivers, additionally knowledge of the density is required in order for the near-surface P-wave velocity to be obtained at step 11.

FIG. 7(d) is a block flow diagram illustrating a method of determining information about near-receiver properties from both S-wave events and P-wave events according to another embodiment of the present invention. Steps 1 to 7 of FIG. 7(d) correspond to steps 1 to 7 of FIG. 4(b), and steps 8-11 of FIG. 7(c) correspond to steps 2, 3, 4 and 5 of FIG. 7(b), and detailed description of the steps will not be repeated. In the method of FIG. 7(d), if the near-surface S-wave velocity is determined at step 5 this may be used as one input in the determination of information about the near-receiver properties at step 11, as indicated by the broken line from step 5 to step 11.

It should be noted that the description has considered only the case of a 1-D acquisition geometry in which the source array is inline with the receiver array, so that the Y-component (the cross-line component) need not be considered. In the general case the Y-component of particle motion may have a non-zero component, so that partition rates involving the Y-component of particle motion may be non-zero, and so may also be used to obtain information about near-receiver properties.

FIG. 8 is a schematic block diagram of a programmable apparatus 16 according to the present invention. The apparatus comprises a programmable data process 17 with a programme memory 18, for instance in the form of a read-only memory (ROM), storing a programme for controlling the data processor 17 to perform any of the processing methods described above. The apparatus further comprises non-volatile read/write memory 19 for storing, for example, any data which must be retained in the absence of power supply. A “working” or scratch pad memory for the data processor is provided by a random access memory (RAM) 20. An input interface 21 is provided, for instance for receiving commands and data. An output interface 22 is provided, for instance for displaying information relating to the progress and result of the method. Data for processing may be supplied via the input interface 21, or may alternatively be retrieved from a machine-readable data store 23.

The programme for operating the system and for performing any of the methods described hereinbefore is stored in the programme memory 18, which may be embodied as a semi-conductor memory, for instance of the well-known ROM type. However, the programme may be stored in any other suitable storage medium, such as magnetic data carrier 18a, such as a “floppy disk” or CD-ROM 18b.

While the principles of the disclosure have been described above in connection with specific apparatuses and methods, it is to be clearly understood that this description is made only by way of example and not as limitation on the scope of the invention.

1. A method of processing multi-component seismic data, the method comprising:
determining, in the time-offset domain, a first partition rate for a first event from the multi-component seismic data; and
obtaining first information about near-receiver properties of the earth from the first partition rate.

2. A method as claimed in claim 1 and further comprising:
determining, in the time-offset domain, at least a second partition rate for the first event from the multi-component seismic data; and
obtaining second information about near-receiver properties of the earth from the second partition rate.

3. A method as claimed in claim 1 and further comprising:
determining, in the time-offset domain, at least a third partition rate for a second event from the multi-component seismic data; and
obtaining third information about near-receiver properties of the earth from the third partition rate.

4. A method as claimed in claim 2 and further comprising combining the second and/or third information about near-receiver properties of the earth with the first information about near-receiver properties of the earth.

5. A method as claimed in claim 1 and wherein the first event is a P-wave event, the first partition rate is the polarisation angle for the P-wave event and wherein the first information about the near-receiver properties of the earth is obtained from the determined polarisation angle of the P-wave event and the horizontal slowness of the P-wave event.

6. A method as claimed in claim 5 wherein information about the near-receiver properties of the earth comprises information about the near-surface S-wave velocity.

7. A method as claimed in claim 6 and comprising determining the near-surface S-wave velocity according to:
$$β = \sqrt{\frac{1 - {( 1 + {tan}^{2} φ )}^{- \frac{1}{2}}}{2 {p}^{2}}}$$
where β is the velocity of the S-wave, p is the horizontal slowness of the P-wave event and φ is the polarisation angle of the P-wave event.

8. A method as claimed in claim 5 wherein the information about near-receiver properties of the earth comprises information about the near-surface S-wave velocity and the density of the earth just below the seafloor.

9. A method as claimed claim 3, wherein the second event is a second P-event and the third partition rate is the polarisation angle of the second P-wave event from the multi-component seismic data, and wherein the third information about the near-receiver properties of the earth is obtained from the determined polarisation angle of the second P-wave event and the horizontal slowness of the second P-wave event.

10. A method as claimed in claim 1 and comprising determining the first information about the near-receiver properties of the earth for a first frequency.

11. A method as claimed in claim 10 and further comprising determining, from the event(s), information about the near-receiver properties of the earth for at least a second frequency.

12. A method as claimed in claim 5 and further comprising determining the horizontal slowness of the P-wave event(s) from the multi-component seismic data.

13. A method as claimed in claim 1, wherein the first event is an S-wave event, the first partition rate is the polarisation angle of the S-wave event and the first information about the near-receiver properties of the earth is obtained from the determined polarisation angle of the S-wave event and the horizontal slowness of the S-wave event.

14. A method as claimed in claim 13 wherein the first information about the near-receiver properties of the earth comprises information about the near-surface P-wave velocity and near-surface S-wave velocity.

15. A method as claimed in claim 13 wherein the first information about the near-receiver properties of the earth comprises information about the near-surface P-wave velocity, near-surface S-wave velocity and the density.

16. A method as claimed in claim 3 wherein the second event is a second S-wave event, the third partition rate is the polarisation angle of the second S-wave event and the third information about the near-receiver properties of the earth is obtained from the determined polarisation angle of the second S-wave event and the horizontal slowness of the second S-wave event.

17. A method as claimed in claim 13 and comprising determining, from the polarisation angle of the S-event(s) information about near-receiver properties of the earth for a first frequency.

18. A method as claimed in claim 17 and further comprising determining, from the polarisation angle of the S-wave event(s), information about near-receiver properties of the earth for at least a second frequency.

19. A method as claimed in claim 1 and comprising carrying one or more further processing steps on the acquired seismic data taking account of the obtained information about the near-receiver properties of the earth.

20. A method as claimed in claim 1 and further comprising acquiring the multicomponent seismic data.

21. A method as claimed in claim 1 and further comprising retrieving the multicomponent seismic data.

22. A computer-readable medium containing instructions that, when executed by a processor, cause the processor to perform a method as defined in claim 1.

23. An apparatus for processing multi-component seismic data, the apparatus being adapted to:
determine, in the time-offset domain, a first partition rate for a first event from the multi-component seismic data; and
obtain first information about near-receiver properties of the earth from the first partition rate.
